(19) United States
(12) Patent Application Publication
(10) Pub. No.: US 2010/0118933 A1
(43) Pub. Date: May 13, 2010

(54) REFERENCE PICTURE LIST MANAGEMENT

(75) Inventors: Purvin Bibhas Pandit, Franklin Park, NJ (US); Peng Yin, West Windsor, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing, Boulogne-Billancourt (FR)

(21) Appl. No.: 12/450,098

(22) PCT Filed: Mar. 17, 2008
(86) PCT No.: PCT/US2008/003492

§ 371 Date: Sep. 10, 2009

Related U.S. Application Data
(60) Provisional application No. 60/921,713, filed on Apr. 4, 2007.

(51) Int. Cl. H04N 11/04

(52) U.S. Cl. 375/240.01; 375/E07.001

(57) ABSTRACT

A change to the high level syntax of the H.264/MPEG-4 AVC based Multiview Coding standard is made to allow for efficient management of the reference pictures lists. The invention allows for inter-view reference pictures to be duplicated in the final reference list by modifying the equation that is used to select the index of the inter-view picture that is to be added to the reference list. Duplication of a reference picture is valuable when a modified version of the reference picture is used as a reference picture along with the original reference picture, such as in weighted prediction and adaptive reference filtering. An efficient implementation of the reordering of reference pictures is also achieved through an implementation of the invention. Reordering of reference pictures can improve coding efficiency by enabling pictures that are more correlated to the current picture to be present in the lower indices of the reference picture list. In the MVC extension, a new set of RPLR commands were introduced to reorder inter-view reference pictures. The equations specified in the derivation of the view index value in the current MVC specification are modified to allow management of the reference pictures lists through another implementation of the invention. This modification removes the restrictions imposed in the current specification and additionally allows duplication of an interview reference picture in the reference list.

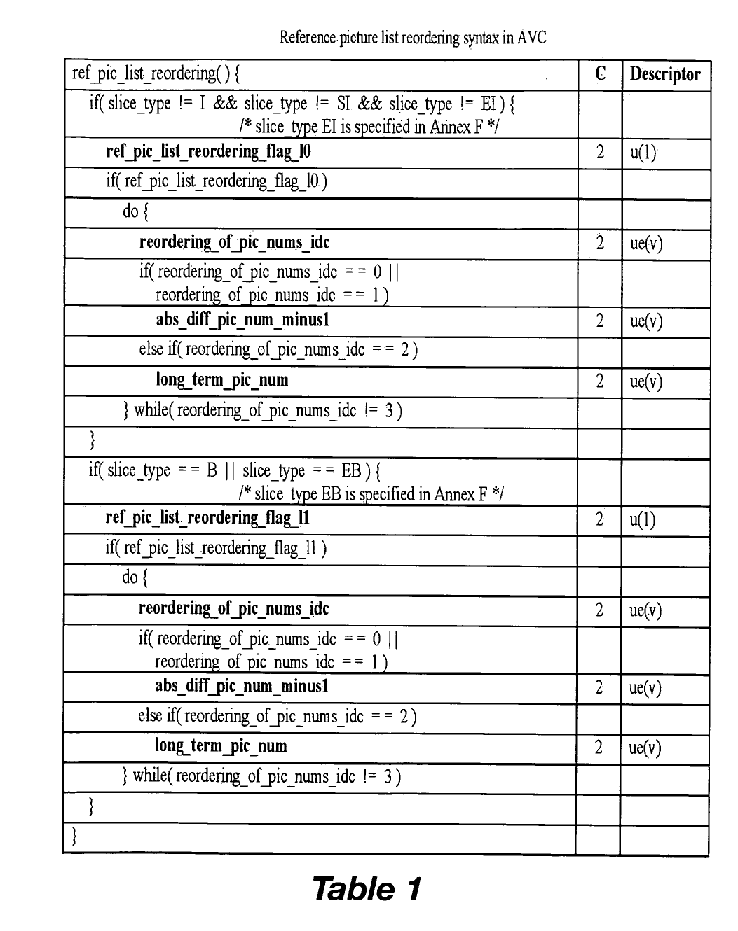

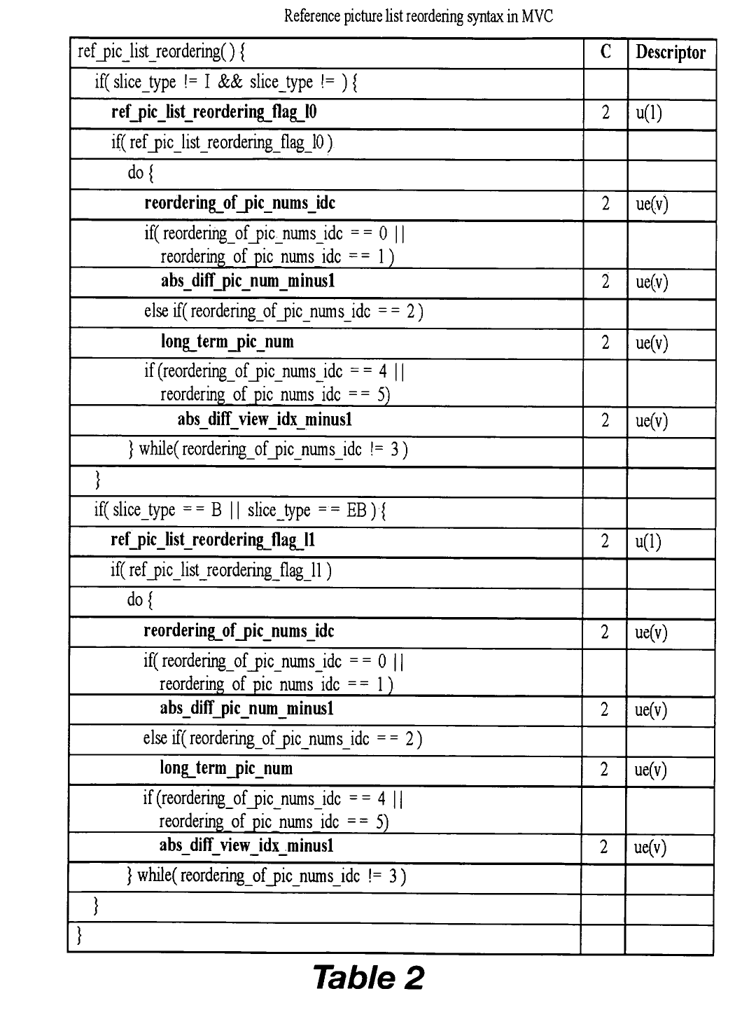

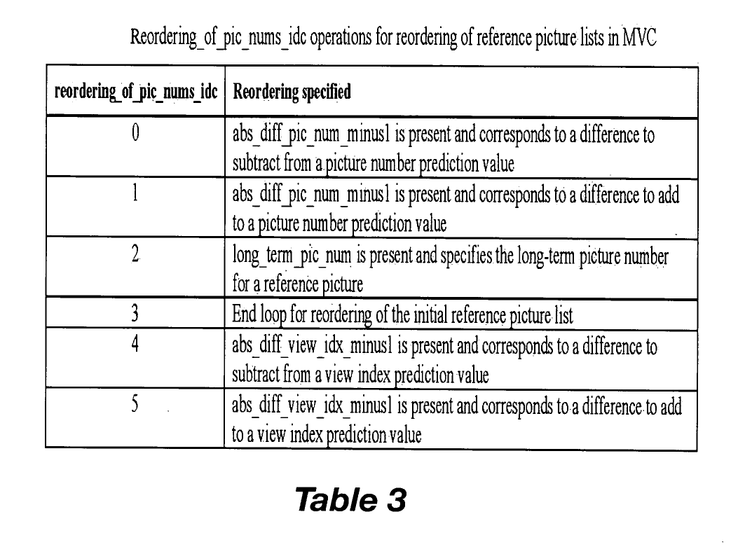

### CROSS-REFERENCE TO RELATED APPLICATIONS

This application claims the benefit of U.S. Provisional Application Ser. No. 60/921,713, filed Apr. 4, 2007, which is incorporated by reference herein in its entirety.

### TECHNICAL FIELD

The present principles relate generally to video encoding and decoding and, more particularly, to a method and apparatus for reference picture list management in multi-view coded video using high level syntax.

### BACKGROUND OF THE INVENTION

In the current H.264/MPEG-4 AVC based implementation of MVC, the reference software achieves multi-view prediction by encoding each view with a single encoder and taking into consideration the cross-view references. In addition MVC also decouples the frame_num and POC between the different views thus allowing pictures with the same frame_num and POC (for example, pictures belonging to different views) to be present in the Decoded Picture Buffer (DPB). These pictures are differentiated using the view_id associated with it.

The Reference Picture List Reordering commands that are used to reorder inter-view reference pictures imposes some restriction on the values of certain syntax elements and additionally does not allow to duplicate a picture with a particular view_id in the reference list. Duplication of a reference picture is useful, for example, in cases where a modified version of the reference picture is used as a reference picture along with the original reference picture. This is used in weighted prediction and adaptive reference filtering.

### SUMMARY OF THE INVENTION

In at least one implementation of the invention, a change to the high level syntax of the H.264/MPEG-4 AVC based Multiview Coding standard is made to allow for efficient management of the reference pictures lists. In particular, the invention allows for inter-view reference pictures to be duplicated in the final reference list by modifying the equation that is used to select the index of the inter-view picture that is to be added to the reference list. Duplication of a reference picture is useful, for example, in cases where a modified version of the reference picture is used as a reference picture along with the original reference picture. This is used in weighted prediction and adaptive reference filtering.

Reordering of reference pictures is also more efficiently implemented through an implementation of the invention. Reordering of reference pictures is useful, for example, to improve coding efficiency by enabling pictures that are more correlated to the current picture to be present in the lower indices of the reference picture list. In the MVC extension, a new set of RPLR commands were introduced to reorder inter-view reference pictures. This is shown in Table 2.

In at least one implementation of the invention, the equations specified in the derivation of the view index value in the current MVC specification are modified to allow management of the reference pictures lists. This modification removes the restrictions imposed in the current specification and additionally allows duplicating an interview reference picture in the reference list.

### BRIEF DESCRIPTION OF THE DRAWINGS

Table 1 shows the Reference picture list reordering syntax in AVC.

Table 2 shows the Reference picture list reordering syntax in MVC.

Table 3 shows the Reordering_of_pics_nums_idc operations for reordering of reference picture lists in MVC.

### DETAILED DESCRIPTION OF THE INVENTION

In at least one implementation of the invention, a change to the high level syntax of the H.264/MPEG-4 AVC based Multiview Coding standard is made to allow for efficient management of the reference pictures lists. In particular, the invention allows for inter-view reference pictures to be duplicated in the final reference list by modifying the equation that is used to select the index of the inter-view picture that is to be added to the reference list.

In the current H.264/MPEG-4 AVC based implementation of MVC, the reference software achieves multi-view prediction by encoding each view with a single encoder and taking into consideration the cross-view references. In addition MVC also decouples the frame_num and POC between the different views thus allowing pictures with the same frame_num and POC (for example, pictures belonging to different views) to be present in the DPB. These pictures are differentiated using the view_id associated with it.

The Reference Picture List Reordering commands that are used to reorder inter-view reference pictures imposes some restriction on the values of certain syntax elements and additionally does not allow to duplicate a picture with a particular view_id in the reference list. Duplicating of a reference picture is useful, for example, in cases where a modified version of the reference picture is used as a reference picture along with the original reference picture. This is used in weighted prediction and adaptive reference filtering.

H.264/MPEG-4 AVC enables encoder/decoder to change default order of reference pictures in list0 (and list1 for Bslices) temporarily for the next decoded slice. This is achieved through Reference Picture List Reordering (RPLR) commands present in the slice header. These RPLR commands are shown in the syntax table for RPLR in

### Table 1.

Reordering of reference pictures is useful, for example, to improve coding efficiency by enabling pictures that are more correlated to the current picture to be present in the lower indices of the reference picture list. In the MVC extension, a new set of RPLR commands were introduced to reorder inter-view reference pictures. This is shown in Table 2.

The semantics for the new RPLR commands are shown in Error! Reference source not found. Further the syntax abs_diff_view_idx_minus1 has the following semantics.

abs_diff_view_idx_minus1 plus 1 specifies the absolute difference between the view index of the picture to put to the current index in the reference picture list and the view index prediction value. abs_diff_view_idx_minus1 shall be in the range of 0 to num_anchor_refs_IX[curr_view_id]−1 if the current decoding slice belongs to an anchor picture, or 0 to num_non_anchor_refs_IX[curr_view_id]−1 if it belongs to a non-anchor picture. curr_view_id is equal to the view_id of the view containing the current slice. The allowed values of abs_diff_view_idx_minus1 are further restricted as specified in subclause H.8.2.2.3 of MVC.

A view index of an inter-view picture indicates the order of the view_id of the inter-view picture occurring in the dependency for current decoding view in MVC SPS extension. For a picture with view index equal to view_index, its view_id is equal to anchor_ref_IX[curr_view_id][view_index] if the current coding slice belongs to an anchor picture, or is equal to non_anchor_ref_IX[curr_view_id][view_index] if it belongs to a non-anchor picture.

TABLE 1
Reference picture list reordering syntax in AVC

| | | |
|---|---|---|
| ref_pic_list_reordering( ) { | C | Descriptor |

if( slice_type != I && slice_type != SI && slice_type != EI ) {

/* slice_type EI is specified in Annex F */

| | | |
|---|---|---|
| ref_pic_list_reordering_flag_l0 | 2 | u(l) |
| if( ref_pic_list_reordering_flag_l0 ) | | |

do {

| | | |
|---|---|---|
| reordering_of_pic_nums_idc | 2 | ue(v) |
| if( reordering_of_pic_nums_idc == 0 \|\| | | |

| | | |
|---|---|---|
| reordering_of_pic_nums_idc == 1 ) | | |
| abs_diff_pic_num_minus1 | 2 | ue(v) |

else if( reordering_of_pic_nums_idc == 2 )

| | | |
|---|---|---|
| long_term_pic_num | 2 | ue(v) |

} while( reordering_of_pic_nums_idc != 3 )

}
if( slice_type == B || slice_type == EB ) {

/* slice_type EB is specified in Annex F */

| | | |
|---|---|---|
| ref_pic_list_reordering_flag_l1 | 2 | u(l) |
| if( ref_pic_list_reordering_flag_l1 ) | | |

do {

| | | |
|---|---|---|
| reordering_of_pic_nums_idc | 2 | ue(v) |
| if( reordering_of_pic_nums_idc == 0 \|\| | | |

| | | |
|---|---|---|
| reordering_of_pic_nums_idc == 1 ) | | |
| abs_diff_pic_num_minus1 | 2 | ue(v) |

else if( reordering_of_pic_nums_idc == 2 )

| | | |
|---|---|---|
| long_term_pic_num | 2 | ue(v) |

} while( reordering_of_pic_nums_idc != 3 )

}

}

TABLE 2
Reference picture list reordering syntax in MVC

| | | |
|---|---|---|
| ref_pic_list_reordering( ) { | C | Descriptor |

if( slice_type != I && slice_type != ) {

| | | |
|---|---|---|
| ref_pic_list_reordering_flag_l0 | 2 | u(l) |
| if( ref_pic_list_reordering_flag_l0 ) | | |

do {

| | | |
|---|---|---|
| reordering_of_pic_nums_idc | 2 | ue(v) |
| if( reordering_of_pic_nums_idc == 0 \|\| | | |

| | | |
|---|---|---|
| reordering_of_pic_nums_idc == 1 ) | | |
| abs_diff_pic_num_minus1 | 2 | ue(v) |

else if( reordering_of_pic_nums_idc == 2 )

| | | |
|---|---|---|
| long_term_pic_num | 2 | ue(v) |

if (reordering_of_pic_nums_idc == 4 ||

reordering_of_pic_nums_idc == 5)

| | | |
|---|---|---|
| abs_diff_view_idx_minus1 | 2 | ue(v) |

} while( reordering_of_pic_nums_idc != 3 )

}
if( slice_type == B || slice_type == EB ) {

| | | |
|---|---|---|
| ref_pic_list_reordering_flag_l1 | 2 | u(l) |
| if( ref_pic_list_reordering_flag_l1 ) | | |

do {

| | | |
|---|---|---|
| reordering_of_pic_nums_idc | 2 | ue(v) |
| if( reordering_of_pic_nums_idc == 0 \|\| | | |

| | | |
|---|---|---|
| reordering_of_pic_nums_idc == 1 ) | | |
| abs_diff_pic_num_minus1 | 2 | ue(v) |

else if( reordering_of_pic_nums_idc == 2 )

| | | |
|---|---|---|
| long_term_pic_num | 2 | ue(v) |

if (reordering_of_pic_nums_idc == 4 ||

| | | |
|---|---|---|
| reordering_of_pic_nums_idc == 5) | | |
| abs_diff_view_idx_minus1 | 2 | ue(v) |

} while( reordering_of_pic_nums_idc != 3 )

}

}

TABLE 3
reordering_of_pic_nums_idc operations for reordering of reference picture lists in MVC

| reordering_of_pic_nums_idc | Reordering specified |
|---|---|
| 0 | abs_diff_pic_num_minus1 is present and corresponds to a difference to |
| | subtract from a picture number prediction value |
| 1 | abs_diff_pic_num_minus1 is present and corresponds to a difference to add |
| | to a picture number prediction value |
| 2 | long_term_pic_num is present and specifies the long-term picture number for |
| | a reference picture |
| 3 | End loop for reordering of the initial reference picture list |
| 4 | abs_diff_view_idx_minus1 is present and corresponds to a difference to |
| | subtract from a view index prediction value |
| 5 | abs_diff_view_idx_minus1 is present and corresponds to a difference to add |
| | to a view index prediction value |

In at least one implementation, the invention modifies the equations specified in the derivation of the view index value in the current MVC specification for management of the reference pictures lists. This modification removes the restrictions imposed in the current specification and additionally allows duplicating an interview reference picture in the reference list.

The reordering process of inter-view pictures is currently specified as:

Inputs to this process are reference picture list RefPicListX (with X being 0 or 1) and an index refIdxLX into this list.

Outputs of this process are a possibly modified reference picture list RefPicListX (with X being 0 or 1) and the incremented index refIdxLX.

The variable picViewIdxLX is derived as follows.

If reordering_of_pic_nums_idc is equal to 4

picViewIdxLX = picViewIdxLXPred −
(abs_diff_view_idx_minus1 + 1 ) (1)

Otherwise (reordering_of_pic_nums_idc is equal to 5),

picViewIdxLX = picViewIdxLXPred +
(abs_diff_view_idx_minus1+ 1 ) (2)

picViewIdxLXPred is the prediction value for the variable picViewIdxLX. When the process specified in this subclause is invoked the first time for a slice (that is, for the first occurrence of reordering_of_pic_nums_idc equal to 4 or 5 in the ref_pic_list_reordering( ) syntax), picViewldxL0Pred and picViewldxL1Pred are initially set equal to 0. When the process specified in this subclause is invoked the first time for a slice and reordering_of_pic_nums_idc is equal to 4 and the followed abs_diff_view_idx_minus1 is equal to 0, the picViewIdxLX is derived directly as 0 without using the above equations. After each assignment of picViewIdxLX, the value of picViewIdxLX is assigned to picViewIdxLXPred.

The following procedure is conducted to place the inter-view picture with view index equal to picViewIdxLX into the index position refldxLX, shift the position of any other remaining pictures to later in the list, as follows.

TargetViewID =num_multiview_refs_for_listX[picViewIdxLX]
for( cIdx = num_ref_idx_IX_active_minus1 + 1; cIdx > refIdxLX;
cIdx−− )

RefPicListX[ cIdx ] = RefPicListX[ cIdx − 1]

RefPicListX[ refIdxLX++ ] = inter-view reference picture with view
id equal to TargetViewID
nIdx = refIdxLX
for( cIdx = refIdxLX; cIdx <= num_ref_idx_IX_active_minus1 +
1; cIdx++ )

if( ViewID(RefPicListX[ cIdx ]) != TargetViewID ||

PictureOrderCnt(RefPicListX[ cIdx ])!=CurrPOC )

RefPicListX[ nIdx++ ] = RefPicListX[ cIdx ]

Where CurrPOC indicates the PicOrderCnt( ) of the current decoding
picture.

As seen from the above description that it imposes the following restriction: When the process specified in this subclause is invoked the first time for a slice and reordering_of_pic_nums_idc is equal to 4 and the next syntax element of abs_diff_view_idx_minus1 is equal to 0, then the picViewIdxLX is derived directly as 0 without using the above equations. This precludes the possibility of having a negative value for picViewIdxLX if, for example, picViewIdxLXPred and abs_diff_view_idx_minus1 both have initial values of zero.

Additionally using the equations of (1) and (2) it is not possible to duplicate the entries in the reference list since these equations will generate incorrect values.

In order to address these issues, at least one implementation proposes to modify the two equations (1) and (2) in the following way.

The variable picViewIdxLX is derived as follows.

If reordering_of_pic_nums_idc is equal to 4

if(picViewIdxLXPred − ( abs_diff_view_idx_minus1 + 1 ) < 0)

picViewIdxLX = picViewIdxLXPred − ( abs_diff_view_idx_minus1 + 1 ) +

MaxViewIdx (3)

else

picViewIdxLX = picViewIdxLXPred − ( abs_diff_view_idx_minus1 + 1 )

Otherwise (reordering_of_pic_nums_idc is equal to 5),

if(picViewIdxLXPred + ( abs_diff_view_idx_minus1 + 1 ) >= MaxViewIdx)

picViewIdxLX = picViewIdxLXPred + ( abs_diff_view_idx_minus1 + 1 ) −

MaxViewIdx (4)

else

picViewIdxLX = picViewIdxLXPred + ( abs_diff_view_idx_minus1 + 1 )

MaxViewIdx is a variable, and the value MaxViewIdx in equations (3) and (4) is derived using the syntax from the SPS MVC extension as follows:

If the current picture is an anchor picture then,

MaxViewIdx = num_anchor_refs_IX[curr_view_id]

Otherwise,

MaxViewIdx = num_non_anchor_refs_IX[curr_view_id]

Clearly, both the encoder and the decoder can derive the values of MaxViewIdx.

An advantage of this method is that by signaling abs_diff_view_idx_minus1 to a value equal to (MaxViewIdx−1) it is possible to duplicate a particular view index value. That is, by using the syntax of Table 2 to signal such a value, then a particular view index value will be duplicated in the reference list of the decoder because picViewIdxLX=picViewIdxLXPred.

Additionally, this method removes the constraint that was originally imposed on the value of abs_diff_view_idx_minus1 when “reordering_of_pic_nums_idc=4” is the first command for the slice. That is, picViewIdxLX need not be automatically set to zero. This follows because the first “if” statement just above equation (3) catches the occurrence of a potentially invalid value for picViewIdxLX (as computed with the existing equation (1)).

Features and aspects described herein allow, for example, duplicating an interview reference picture in a reference picture list. Such duplication may refer merely to duplicating a pointer to an actual reference picture (that includes the pixel values), in which case the reference picture list may, for example, include a series of pointers to one or more actual reference pictures. The actual reference pictures may be stored, for example, in a decoded picture buffer. In such an implementation, one or more of the pointers in the reference picture list are duplicated so that the pointers point to the same actual reference picture.

Duplication of interview reference pictures in a reference picture list may be used, for example, in performing adaptive reference filtering as described in U.S. Provisional Application Ser. No. 60/807,645, filed Jul. 18, 2006, and titled “Adaptive Reference Frame Filtering for Video Coding”, the entire contents of which are hereby incorporated by reference.

It should be clear that implementations may also duplicate the actual reference picture that is pointed to by multiple pointers in a reference picture list. Further, implementations may maintain a reference picture list that includes the actual reference pictures rather than merely pointers to the actual reference pictures.

Features and aspects of described implementations may also be adapted for other implementations. For example, other encoding/decoding processes that maintain a list of reference pictures may allow for duplication of a reference picture in the list. Such other encoding/decoding processes may allow for such duplication using, for example, explicit signaling or implicit signaling. As an example of explicit signaling, an implementation may include syntax with every encoded picture indicating whether a particular reference picture is to be duplicated in the list.

The implementations described herein may be implemented in, for example, a method or process, an apparatus, or a software program. Even if only discussed in the context of a single form of implementation (for example, discussed only as a method), the implementation or features discussed may also be implemented in other forms (for example, an apparatus or program). An apparatus may be implemented in, for example, appropriate hardware, software, and firmware. The methods may be implemented in, for example, an apparatus such as, for example, a decoder, an encoder, or some other processing device. Additionally, the methods may be implemented by instructions being performed by a processing device or other apparatus, and such instructions may be stored on a computer readable medium such as, for example, a CD or other computer readable storage device, or an integrated circuit.

As should be evident to one of skill in the art, implementations may also produce a signal formatted to carry information that may be, for example, stored or transmitted. The information may include, for example, instructions for performing a method, or data produced by one of the described implementations. For example, a signal may be formatted to carry as data the values for the explicit signaling syntax.

Further, other implementations are contemplated by this application. For example, additional implementations may be created by combining, deleting, modifying, or supplementing various features of the disclosed implementations.

The claims provides a short list of various implementations. The list is not intended to be exhaustive but merely to provide a short description of a small number of the many possible implementations.

1. In a multiview coding format, a method for constructing a reference picture list comprising:
providing information in the bitstream that indicates if a particular reference picture is to be duplicated on a list of reference pictures;
re-ordering to allow the duplication of an interview picture in the reference picture list.

2. The method of claim 1, where an equation to calculate the view index value is modified to allow the duplication.

3. The method of claim 2, where the equation adds the value of a maximum reference index if a certain condition is satisfied.

4. The method of claim 2, where the equation subtracts the value of a maximum reference index if a certain condition is satisfied.

5. The method of claim 3 or implementation 4, where the maximum reference index value is determined from the SPS syntax.

6. The method of claim 5, where the maximum reference index value can be different for anchor and non-anchor pictures.

7. An encoder configured to provide information comprising instructions to achieve duplication of a particular reference picture on a list of reference pictures.

8. The encoder of claim 7, where the information includes a value of an explicit signaling syntax.

9. A decoder configured to duplicate a particular reference picture in a list of reference pictures.

10. Implementation 7 or implementation 9, where the particular reference picture is an interview reference picture.

11. The decoder of claim 9, where said decoder is further configured to receive information instructing that the duplication be performed.

12. The decoder of claim 11, where the information includes a value of an explicit signaling syntax.

13. A method for possible use by an encoder that includes providing information instructing that a particular reference picture is to be duplicated on a list of reference pictures.

14. A method for possible use by a decoder that includes duplicating a particular reference picture in a list of reference pictures.

15. The method of claim 14, where the method further includes receiving information instructing that the duplicating be performed.

16. A computer readable medium including instructions for causing a reference picture to be duplicated in a list of reference pictures maintained by a decoder for use in decoding pictures.

17. The medium of claim 16, where said instructions cause the reference picture to be duplicated in response to receiving a signal instructing such duplication.
